(19) United States
(12) Patent Application Publication
(10) Pub. No.: US 2009/0018688 A1
(43) Pub. Date: Jan. 15, 2009

(54) METHODS AND SYSTEMS FOR DESIGNING AND VALIDATING OPERATION OF ABATEMENT SYSTEMS

(75) Inventors: Phil Chandler, San Francisco, CA (US); Daniel O. Clark, Pleasanton, CA (US); Robbert M. Vermeulen, Pleasant Hill, CA (US); Belynda Flippo, Capitola, CA (US); Mehran Moalem, Cupertino, CA (US); Charles Murray, San Jose, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/139,472

(22) Filed: Jun. 14, 2008

Related U.S. Application Data
(60) Provisional application No. 60/944,485, filed on Jun. 15, 2007.

(51) Int. Cl. G06F 19/00

(52) U.S. Cl. 700/105

(57) ABSTRACT

A method of developing an integrated abatement system is provided, including the steps: a) determining whether an integrated abatement system meets a destruction removal efficiency standard wherein the determination includes the steps: i) operating an electronic device manufacturing process tool using a best known method, whereby effluent containing a target species is produced; ii) abating the target species to form abated effluent, using an abatement system which is coupled to the process tool; and iii) calculating a destruction removal efficiency for the target species; and b) modifying the abatement system by altering at least one of a design parameter and an operating parameter of the abatement system to improve the destruction removal efficiency. Numerous other aspects are provided.

The present application claims priority to U.S. Provisional Patent Application Ser. No. 60/944,485, filed Jun. 15, 2007 and entitled “METHODS AND SYSTEMS FOR VALIDATING OPERATION OF ABATEMENT SYSTEMS” (Attorney Docket No. 12073/L2), which is hereby incorporated herein by reference in its entirety for all purposes.

### RELATED APPLICATIONS

Co-owned U.S. patent application Ser. No. 11/685,993, filed Mar. 14, 2007 and entitled “METHODS AND APPARATUS FOR IMPROVING OPERATION OF AN ELECTRONIC DEVICE MANUFACTURING SYSTEM” (Attorney Docket No. 9137), is hereby incorporated by reference herein in its entirety and for all purposes.

### FIELD OF THE INVENTION

The present invention relates generally to the manufacture of electronic devices and is more particularly directed to the design of integrated abatement systems used to abate undesirable species contained in the exhaust of electronic device manufacturing process tools.

### BACKGROUND OF THE INVENTION

The manufacture of electronic devices typically results in the creation of byproduct effluent gases. These effluent gases may contain undesirable species which may be harmful and/or hazardous. The governments of the United States and of many other countries may closely regulate the amount of undesirable species which may be emitted to the environment. Some regulations may specify a maximum concentration of an undesirable species in the effluent from a fabrication plant and other regulations may specify a maximum mass of an undesirable species which may be emitted from a fabrication plant over a specified period of time.

The operator of an electronic device manufacturing fabrication plant may have an understanding of the amount and concentration of undesirable species which are created by process tools operated in the fabrication plant and may purchase abatement systems to reduce the amount and/or the concentration of the undesirable species which are created by the process tools. The operator, understanding the effluent which is produced by the process tools and the regulations which govern the chemical species which may be emitted from the fabrication plant, may calculate a percentage of the undesirable species in a process tool effluent which must be abated by an abatement system. This percentage may be referred to as a destruction removal efficiency, which will be discussed in more detail below. The operator may specify this destruction removal efficiency to an abatement system manufacturer, who may design the system to this standard.

It is desirable for manufacturers of abatement systems to be able to design abatement systems to provide the desired destruction removal inefficiencies.

### SUMMARY OF THE INVENTION

In one aspect, the present invention provides a method of developing an integrated abatement system including the steps: a) determining whether an integrated abatement system meets a destruction removal efficiency standard wherein the determination includes the steps: i) operating an electronic device manufacturing process tool using a best known method, whereby effluent containing a target species is produced; ii) abating the target species to form abated effluent, using an abatement system which is coupled to the process tool; and iii) calculating a destruction removal efficiency of the target species; and b) modifying the abatement system by altering at least one of a design parameter and an operating parameter of the abatement system to improve the destruction removal efficiency.

In a second aspect, the present invention provides a method of developing an integrated abatement system including the steps: operating an electronic device manufacturing process tool, whereby effluent is produced; abating the effluent using an abatement system which is adapted to abate the effluent from the process tool and to meet destruction removal efficiency standards for the process tool when the process tool is operated using a best known method; stressing the abatement system, wherein stressing the abatement system includes introducing a precursor species into the process tool in an amount greater than an amount prescribed by the best known method; calculating a destruction removal efficiency of the stressed abatement system for a target species; and modifying the abatement system, by altering at least one of a design parameter and an operating parameter of the abatement system, to improve the destruction removal efficiency of the abatement system for the target species.

In a third aspect, the present invention provides a method of developing an integrated abatement system including the steps: operating an electronic device manufacturing process tool using a best known method, whereby effluent is produced; abating the effluent to form abated effluent, using an abatement system which is adapted to abate effluent from the process tool and to meet a destruction removal efficiency standard; measuring a mass flow rate of a target atom entering the abatement system; measuring a mass flow rate of the target atom exiting the abatement system; calculating a mass balance; modifying the abatement system by altering at least one of a design parameter and an operating parameter of the abatement system to improve the mass balance.

Numerous other aspects are provided in accordance with these and other aspects of the invention. Other features and aspects of the present invention will become more fully apparent from the following detailed description, the appended claims and the accompanying drawings.

### BRIEF DESCRIPTION OF THE DRAWINGS

FIG. 1 is a schematic view of an apparatus for performing methods of the present invention.

FIG. 1A is an equation which may be used to calculate a destruction removal efficiency of an abatement system.

FIG. 2 is a second schematic view of an apparatus for performing methods of the present invention.

FIG. 3 is a flow chart depicting a method of the present invention.

FIG. 4 is a flow chart depicting a second method of the present invention.

FIG. 5 is a flow chart depicting a third method of the present invention.

### DETAILED DESCRIPTION

Electronic device manufacturing systems typically employ process chambers for performing manufacturing steps in the production of an electronic device. The process chambers may perform many different types of operations, including deposition, crystal growth, epitaxial crystal growth, etching, cleaning, etc., and may produce undesirable effluents. As described above, these undesirable effluents may include harmful and/or hazardous materials. A harmful and/or hazardous material for which a destruction removal efficiency is calculated may be referred to herein as a target species. This undesirable effluent may need to be abated to avoid harm to persons and/or the environment.

The abatement of undesirable effluent in the exhaust of semiconductor process tools is a key challenge. Today, there may be more than 300 precursor species used in various processes and more than 2000 compounds in the exhaust of semiconductor process tools that may need to be abated. In addition, as new fabrication processes are developed, new precursor species and new compounds in the exhaust of semiconductor process tools may be encountered. Such innovation may require the development of new and/or improved abatement processes. In addition, it may be anticipated that the acceptable levels for release of undesirable species to the environment will decrease, requiring more effective abatement of effluent. The increasing stringency of these personal and environmental protection requirements may also necessitate the development of new and/or improved abatement processes.

Another challenge faced by the electronic device manufacturing industry is that some abatement processes may cause some of the chemical species in the process tool effluent to deposit within an abatement tool. Such deposition may result in the inefficient abatement of effluent, and/or the creation of a dangerous condition. In some cases, the deposition of matter in an abatement tool may become so severe that the abatement tool and the process tool which it supports must be shut down. Shutting down a process tool may cause an expensive piece of capital equipment (which may create a large profit when operating) to lay idle.

In addition to being able to abate effluent from a process tool which is operating within specifications, an abatement system may need to be able to abate a transient increase in an undesirable species. Such transient increases in an undesirable species may occur, for example, when a mass flow controller which is adapted to introduce a precursor compound into a process tool at a measured rate, fails in an open position.

Methods and apparatus for designing abatement systems which are effective to abate effluent from electronic device manufacturing processes, and which are able to prevent or reduce the deposition of materials within abatement tools, are desirable.

The present invention provides methods and apparatus for developing and validating new and/or improved abatement systems and processes. In one embodiment, for example, a process tool may exist or be designed to perform a step in an electronic device manufacturing process. The manufacturer of the process tool typically may create a process recipe which will provide optimal results in the process step. This may be referred to as a best-known method. The same, or a different, manufacturer may design an abatement system which is effective to abate undesirable species which may exist in the process tool effluent when the process tool is operated using best-known methods.

Using the methods and apparatus of the present invention, the manufacturer/designer of the abatement system may analyze the exhaust from a process tool to determine the nature and amount of undesirable species existing in the effluent. Having knowledge of the nature and amount of undesirable species which exist in the effluent, the manufacturer/designer may draw on its own knowledge, and/or publicly available knowledge of abatement technology, to design a first approximation of an effective abatement system. This design may include selecting abatement tools which the manufacturer knows or believes to be effective with the undesirable species contained in the effluent. The manufacturer may then analyze the exhaust from the abatement system and determine whether the exhaust meets environmental standards and is releasable to the atmosphere, or whether the exhaust does not meet environmental standards and the abatement system instead needs to be improved. If the abatement system needs to be improved, the manufacturer may modify the abatement system by selecting different and/or additional abatement tools or by changing the design and/or operating parameters of the abatement tools which make up the abatement system. The process of analyzing the efficiency of the abatement system followed by modifying the abatement system and then re-analyzing the efficiency of the altered system, may be repeated until such time as the abated effluent meets acceptable standards.

The manufacturer/designer, having designed an abatement system which is effective to abate the effluent from the process tool which is operated using a best-known method, may also wish to design the abatement system to effectively abate the effluent from the process tool when the process tool is operated outside of the best-known method. According to another embodiment of the present invention, the abatement system may be stressed by increasing the amount of a precursor material which is provided to the process tool. The increase of the precursor material may result in more of an undesirable species appearing in the effluent from the process tool. The manufacturer may then abate this effluent and analyze the composition of the abated effluent and determine whether the abatement system continues to meet environmental standards or whether additional modifications to the design of the abatement system need to be made. If additional modifications need to be made, the manufacturer may follow the process described above, e.g., selecting a different and/or additional abatement tool or by changing the design and/or operating parameters of one or more abatement tools which make up the abatement system.

In yet another embodiment of the present invention, the manufacturer may determine whether any materials are becoming deposited inside of the abatement system when the abatement system is adapted and operated to effectively abate undesirable species in the effluent from a process tool which is operated using best-known methods. The manufacturer may accomplish this by measuring the mass of materials entering the abatement system and the mass of materials exiting the abatement system. If the manufacturer determines that materials are becoming deposited inside of the abatement system, the manufacturer may alter the abatement system by selecting different abatement tools, different configurations of abatement tools, and/or different abatement tool operating parameters to prevent the materials from becoming deposited inside of the abatement system.

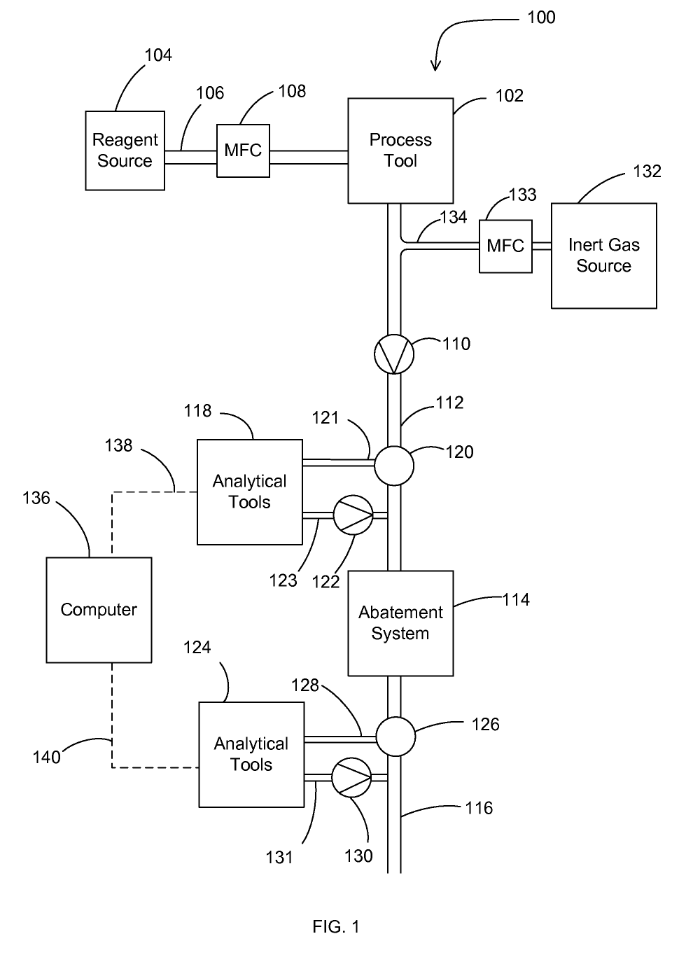

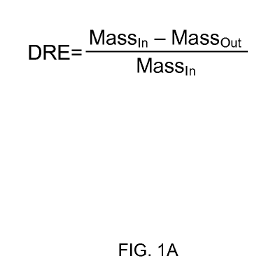

FIG. 1 is a schematic drawing of an electronic device manufacturing system 100 which includes an integrated abatement system. As used herein, an “integrated abatement system” refers to an abatement system which is adapted to effectively abate the effluent from a particular process tool to which it is connected. System 100 may include a process tool 102 which may be adapted to perform one or more process steps in the manufacture of an electronic device. The process tool 102 may be any tool which is used in an electronic device manufacturing fabrication plant which produces effluent as a byproduct. Such process tools may perform deposition, crystal growth, etching, stripping, lithography, etc. Process tool 102 may receive a reagent or precursor material from a reagent source 104 through a conduit 106. Typical reagents or precursor materials may include any reagents which are used in the manufacture of electronic devices. The mass flow rate of the reagent from reagent source 104 to the process tool 102 may be governed by a mass flow controller 108. Any suitable mass flow controller 108 may be used. Although only one reagent source 104 is shown, it is to be understood that more than one reagent may be provided by more than one reagent source 104 through more than one mass flow controller 108.

The process tool 102 may produce an effluent as a byproduct of the manufacturing step which the process tool 102 is performing. A vacuum pump 110 may draw effluent from the process tool 102 through a conduit 112 from which the effluent may enter an abatement system 114. Abatement system 114, which may include one or more abatement tools, such as wet scrubbers, burners, plasma units, filters, oxidizing units, thermal units, dry scrubbers, adsorbing units, absorbing units, catalyst units, and acid gas scrubbers, etc., may be adapted to abate the undesirable species in the process tool effluent and pass the abated effluent through conduit 116 to the atmosphere, a house exhaust system (not shown), or to further abatement systems (not shown).

System 100 may also include analytical tools 118 which may be adapted to determine the concentrations of chemical species in the effluent flowing through conduit 112. Analytical tools 118 may include one or more of a Fourier transform infrared spectrometer (“FTIR”) and a quadrupole mass spectrometer (“QMS”). Any other appropriate analytical tools such as, for example, a fluorine chemiluminescence sensor (“FCS”), an electrolytic cell, etc., may be used as well. The use of FTIR and QMS to measure the composition of an effluent gas flow is described in SEMATECH 1300I, which is hereby incorporated by reference. The use of multiple analytical tools may increase the accuracy of the measurements of species concentrations. Analytical tools 118 may receive a sample of the effluent flowing through conduit 112 through valve 120 and conduit 121. It should be noted that the effluent flowing through conduit 112 is effluent which has not been abated by abatement system 114. Analytical tools 118 may return effluent to conduit 112 through pump 122 and conduit 123. Although a valve 120 is shown at the connection of conduits 112, 121, it should be understood that any suitable connector may be used. In addition, although a simple connection is shown between conduit 123 and conduit 112, it is to be understood that any suitable connector, including a valve, may be used at this connection point.

In addition to analytical tools 118, system 100 may include analytical tools 124. Like analytical tools 118, analytical tools 124 may be adapted to determine the concentration of chemical species in the effluent flowing through conduit 116. It should be noted that the effluent flowing through conduit 116 is effluent which has been abated in abatement system 114. Analytical tools 124 may include the same or different instruments as analytical tools 118. In some embodiments analytical tools 124 and analytical tools 118 may include the same instruments. Analytical tools 124 may receive abated effluent from conduit 116 through valve 126 and conduit 128. Analytical tools 124 may return abated effluent to conduit 116 through pump 130 and conduit 131. Although FIG. 1 depicts the use of valves 120, 126 to divert effluent from conduits 112, 116 to analytical tools 118, 124, it is to be understood that valves 120, 126 may be replaced any suitable couplings.

System 100 may include inert gas source 132, which may be adapted to supply an inert gas through mass flow controller 133 and conduit 134 into conduit 112. Useful inert gases may include krypton, helium, or argon, etc. Krypton works well because it is easy to detect and does not occur in room air to any significant extent. The inert gas from inert gas 132 may be used for several purposes, depending upon the configuration and location of inert gas source 132. For example, inert gas may be used to calibrate instruments, to dilute an effluent to be tested, and as a tool useful and calculating destruction removal efficiency. These uses will be discussed in further detail below.

Finally, system 100 may include computer or controller 136 which may receive data from analytical tools 118, 124 through signal lines 138, 140. Signal lines may be any suitable form of communication medium, including wireless communication. Computer 136 may be used to perform calculations such as destruction removal efficiency and mass balance.

In operation, process tool 102 may receive one or more reagents from reagent supplies 104. Process tool 102 may use the reagents in an electronic device manufacturing process performed on a substrate. As a byproduct of the process conducted by the process tool 102, an effluent gas which contains one or more undesirable species may be produced by the process tool 102. The effluent gas containing the undesirable species may then be abated in abatement system 114.

System 100 may also perform measurements and calculations to calculate a destruction removal efficiency of the abatement system. Thus, the effluent which passes through conduit 112 may also be analyzed by the instruments contained in analytical tools 118. Some of the effluent flowing through conduit 112 may be diverted by valve 120 into analytical tools 118, where the effluent may be analyzed. After being analyzed, the effluent may pass through pump 122 and conduit 123 back into conduit 112. Analytical tools 118 may send information, including the results of analyses performed on the effluent, through signal line 138 to computer 136.

As described above, the effluent exiting from abatement system 114 may be passed to a house exhaust system, the atmosphere, or to further abatement treatment through conduit 116. Some of the effluent passing through conduit 116 may be diverted through valve 126 and conduit 128 into analytical tools 124 where the effluent may be analyzed. Analytical tools 124 may then send data, including the results of the analyses performed on the effluent, through signal line 140 to computer 136.

Inert gas source 132 may supply a flow of inert gas through conduit 136 into conduit 112. In the configuration of FIG. 1, the inert gas may be used by system 100 to calculate mass flow rates of target species.

Mass flows may be important to calculate in cases where the total mass of a target species which can be released to the atmosphere is regulated, as opposed to only the concentration of the target species in the effluent being regulated. Measuring mass flow rates may be important to the calculation of destructive removal efficiency, because in some abatement systems, a large quantity of non-effluent gasses may be introduced into the abatement system. These non-effluent gases may include fuel, oxidants, and/or inert gases, such as nitrogen, for example. Other non-effluent gases may also be used. The introduction of these non-effluent gases into the abatement unit may have the effect of reducing the concentration of the target species in the abated effluent, and giving a false impression of a high destruction removal efficiency.

In one embodiment, an inert gas may be used to calculate a mass flow rate of a target species as follows: the inert gas may be flowed at a known mass flow rate established by mass flow controller 133 into conduit 112, at a location upstream from a location, e.g., valve 120, where the mass flow rate of a target species may be measured; the concentration of the inert gas in the conduit 112 which carries the inert gas and the target species may be measured by analytical tools 118; the concentration of the target species in the conduit which carries the inert gas and the target species may be measured by analytical tools 118; the total mass flow rate of the effluent in the conduit 112 may be calculated by dividing the mass flow rate of the inert gas by the concentration of the inert gas in the conduit 112; and the mass flow rate of the target species may be calculated by multiplying the total flow rate of the effluent by the concentration of the target species in the conduit 112.

Thus, the inert gas injection may make possible an accurate destruction removal efficiency calculation based upon mass flow rates of a target species, as discussed in more detail below.

FIG. 1A is an equation which may be used to calculate a destruction removal efficiency of an abatement system. Thus, in system 100, analytical tools 118 may measure the mass_{In} of a target species and report this measurement to computer 136, and analytical tools 124 may measure the massₒᵤₜ of the selected species and report this measurement to computer 136. Computer 136 may then use the equation of FIG. 1A to calculate the destruction removal efficiency of the abatement system with respect to the selected species using the equation (massᵢₙ-massₒᵤₜ)/massᵢₙ.

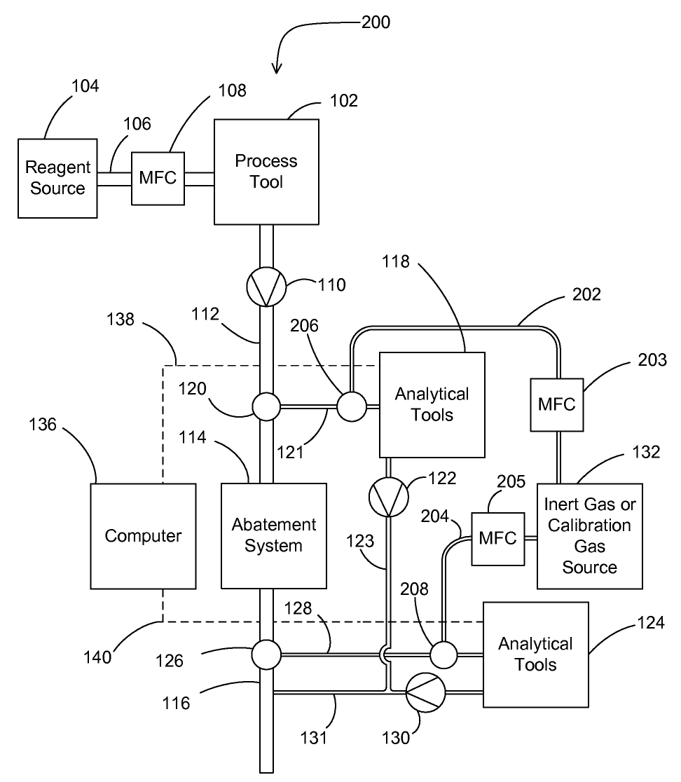

FIG. 2 is a schematic drawing of a second electronic device manufacturing system 200 of the present invention. System 200 is similar to system 100 with the exception that inert gas source 132 is connected to the system through conduits 202, 204 and mass flow controllers 203, 205, instead of through conduit 134 and mass flow controller 133, as in FIG. 1. Conduits 202, 204 connect to conduits 121, 128 through connectors 206, 208. Connectors 206, 208 may be three-way valves or any other suitable connectors. Analytical tools 118, 124 return effluent to conduit 116 through conduits 123, 131. Although conduit 123 is shown connected to conduit 131, conduit 123 may alternatively be connected to conduit 116 directly. In addition, although the connection of conduit 131 to conduit 116 is depicted as a simple connector, the connector may alternatively be a valve.

In operation, system 200 may operate similarly to system 100, with the exception of the inert gas. In this embodiment, inert gas source 132 may supply inert gas directly into the conduits 121, 128 which conduits may feed effluent gases to analytical instruments 118, 124 respectively.

In one embodiment of the present invention inert gas may be used to calibrate the analytical instruments 118, 124. By flowing a known mass of inert gas into the analytical instruments 118, 124, the instruments may be calibrated. In another embodiment of the present invention, inert gas may be used to dilute the effluent gas in conduits 121, 128, so that a target species concentration may be reduced by a known dilution factor to a concentration which falls within a range within which the instruments of analytical tools 118, 124 are more sensitive. By knowing how much inert gas was introduced into the effluent gas to dilute the target species, the actual concentration of the target species may be calculated. This may be useful, because the instruments may be used to detect species which are present in the effluent gas in wide ranges of composition, and it may be impractical to modify the sensitivity ranges of the instruments during operation of the system 200.

It should be noted that the systems 100 and 200 may be combined such that the inert gas or calibration gas source may located in both depicted locations so that all three uses for the inert gas/calibration gas may be employed in one system.

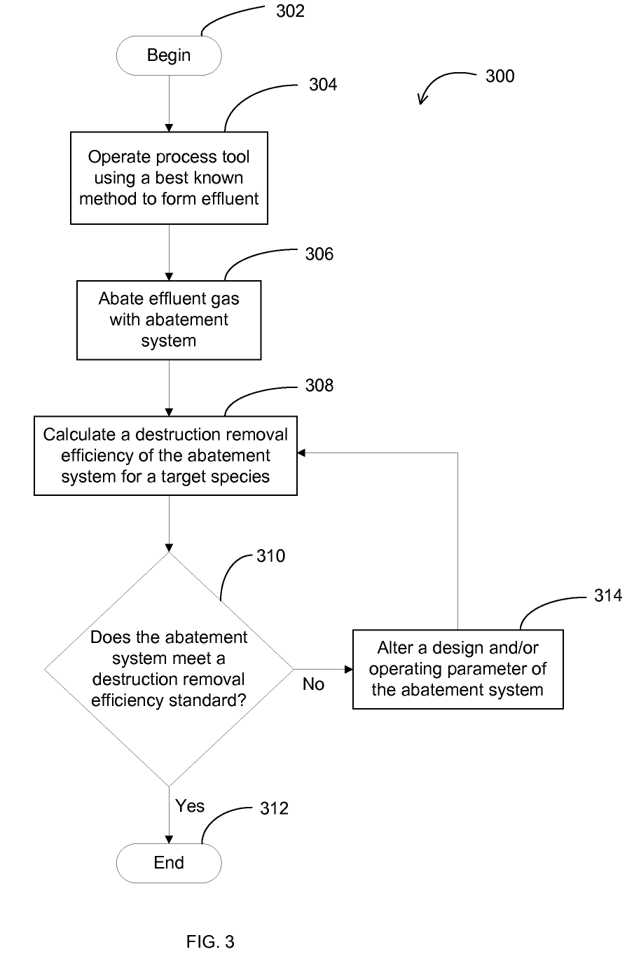

FIG. 3 is a flowchart depicting a method for designing an integrated abatement system 300 of the present invention. The method begins in step 302. In step 304, an electronic device manufacturing process tool is operated using a best-known method. In step 306, the effluent gas from the process tool is abated with an abatement system. One of ordinary skill in the abatement art will be able to design an initial abatement system to use in step 306 based on knowledge of the process being performed in the process chamber and familiarity with available abatement components. Thus, the abatement system used in step 306 to abate the effluent may be more or less appropriate for abating the effluent. In step 308, a destruction removal efficiency of the abatement system for a target species is calculated for the initial abatement system, as described above with respect to FIG. 1A. In step 310, the destruction removal efficiency of the abatement system for the target species is compared to a destruction removal efficiency standard. The standard may be selected in accordance with the requirements of a customer for whom the system is being designed. If the destruction removal efficiency of the abatement system for the target species meets or exceeds the destruction removal efficiency standard, the method 300 may end in step 312. If, instead, the destruction removal efficiency of the abatement system for the target species fails to meet the destruction removal efficiency standard, the abatement system is modified in step 314 by altering a design and/or an operating parameter of the abatement system and/or abatement tools which make up the abatement system.

The selection of a design parameter may include a selection of an abatement tool type, a size of an abatement tool, a flow capacity of an abatement tool, a configuration of an abatement tool, a configuration of the abatement system (for example, the order of abatement tools in the abatement system), etc. and the selection of an operational parameter may include selecting how an abatement tool, which is already incorporated into the abatement system, is operated. For example, operational parameters may include fuel flow rate, water flow rate, oxidant flow rate, region flow rate, plasma flow rate, electrical power, inert gas flow rate, etc. Other operational parameters may also be altered.

After modifying the abatement system, step 308 is repeated and a destruction removal efficiency of the modified abatement system for the target species is calculated. Steps 308, 314, and 310, may be repeated until the abatement system meets the destruction removal efficiency standard for the target species, at which point the method 300 may end in step 312.

During step 314, wherein the abatement system is modified, the process tool may continue to be operated or may be shut down. If the process tool is continued to be operated while the abatement system is modified, then the effluent gas may be diverted to a secondary abatement system or shunted directly into the house abatement system. If the process tool is shut down during modification of the abatement system, then, before returning to step 308, steps 304 and 306 must be started again.

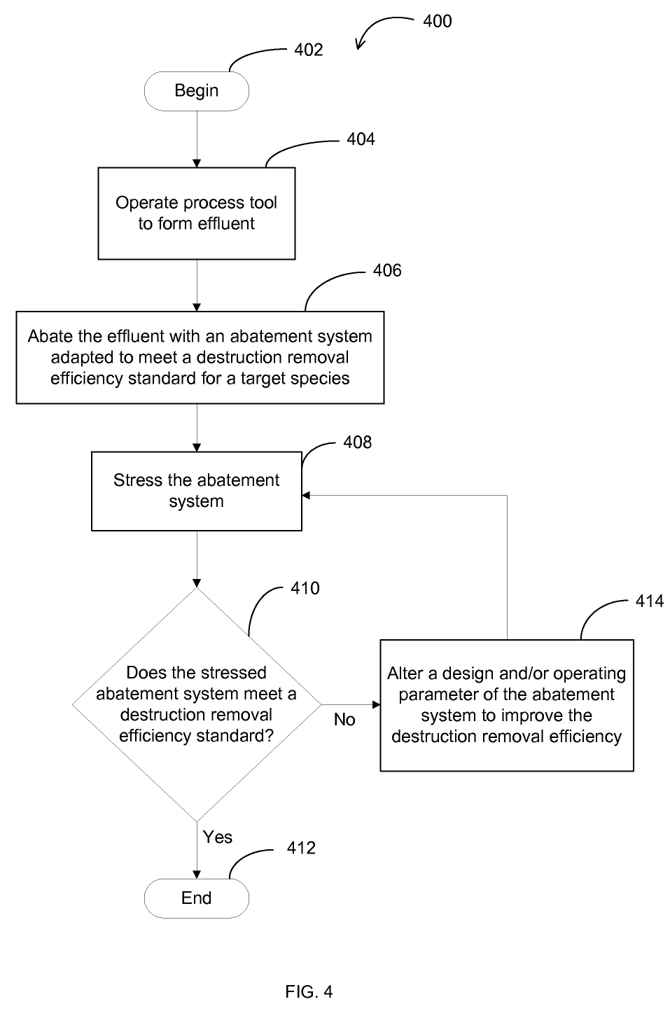

FIG. 4 is a flowchart depicting a second method for designing an integrated abatement system 400 of the present invention. Method 400 begins in step 402. In step 404, an electronic device manufacturing process tool is operated, whereby an effluent is formed. The effluent is abated in step 406 using an abatement system which is adapted to meet a destruction removal efficiency standard for a target species which is exhausted from a process tool with which the abatement system is integrated. At this point in the method, the effluent from the process tool is successfully abated to meet the destruction removal efficiency standard. This may result in a steady state operation. In step 408, the abatement system is stressed by deviating from a best-known method for operating the process tool. This may be accomplished by, for example, increasing the mass flow of a precursor material above the mass flow prescribed by the best-known method. One reason for stressing the abatement system in this fashion may be to ensure or certify that an abatement system will continue to effectively abate the effluent from a process tool in the event that a precursor mass flow controller fails in the full open position. In step 410, the destruction removal efficiency of the stressed abatement system is measured and compared to a destruction removal efficiency standard for the integrated abatement system. If the stressed abatement system continues to meet the destruction removal efficiency standard for the target species, the process may end in step 412. However, if the stressed abatement system fails to meet the destruction removal efficiency standard for the target species, the method may pass to step for 414 wherein the abatement system is modified by altering a design and/or an operating parameter of the abatement system to improve the destruction removal efficiency for the target species. The method may then pass to step 408, where the abatement system is continued to be stressed, and then to step 410, where the destruction removal efficiency of the abatement system is re-measured. Steps 414, 408 and 410 may be repeated until the stressed abatement system meets the destruction removal efficiency standard for the target species. The method may then pass to step 412 where the method 400 ends.

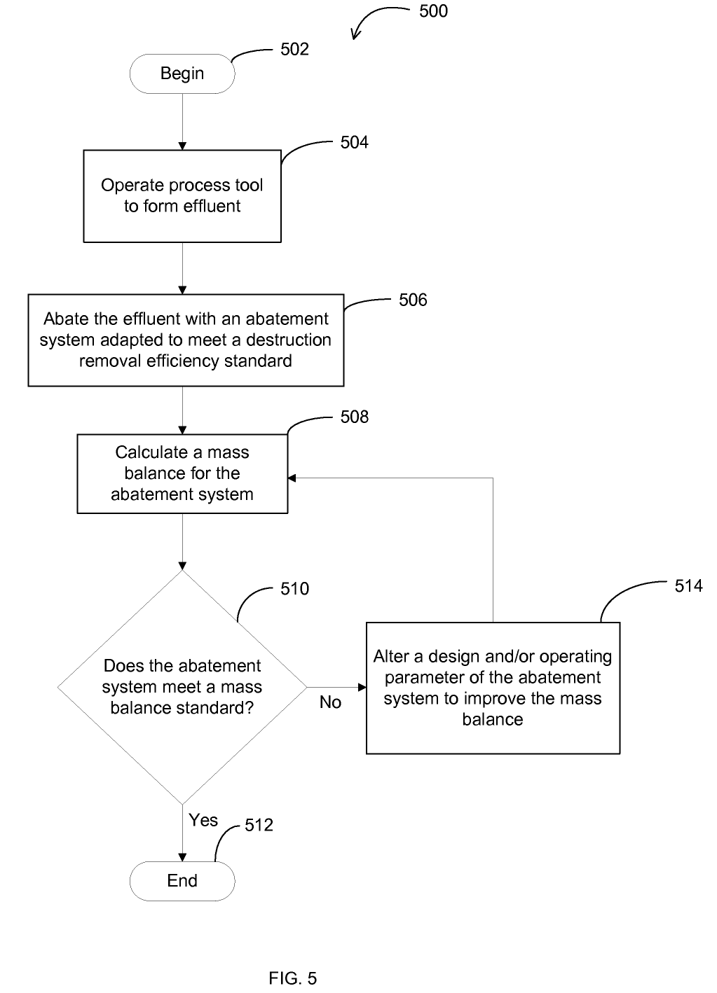

FIG. 5 is a flowchart depicting another method 500 of designing an abatement system of the present invention. The method begins in step 502. In step 504, a process tool is operated using a best-known method whereby effluent is formed. In step 506, the effluent is abated with an abatement system which may be adapted to meet a destruction removal efficiency standard for a target species. The method passes to step 508 where a mass balance is calculated for the abatement system. As described above, the mass balance may be calculated for a target atomic species by measuring the massᵢₙ of the target atomic species in conduit 112, measuring the massₒᵤₜ of the target species in conduit 116, and then subtracting massₒᵤₜ from massᵢₙ and dividing the result by massᵢₙ.

If the mass balance for the abatement system meets a mass balance standard, the method may end in step 512. However, if the abatement system does not meet the mass balance standard, the abatement system is modified by altering a design and/or an operating parameter of the abatement system and/or an abatement tool to improve the mass balance. Steps 514, 508 and 510 may be repeated until the abatement system does meet the mass balance standard, at which time the method may pass to step 512 where the method 500 ends.

The foregoing description discloses only exemplary embodiments of the invention. Modifications of the above disclosed apparatus and methods which fall within the scope of the invention will be readily apparent to those of ordinary skill in the art. For example, instruments which may measure the concentration of target species in the waste water from an abatement system may be used to add this measure to the calculations of destruction removal efficiency and mass balance.

The invention claimed is:

1. A method of developing an integrated abatement system comprising the steps:
a) determining whether an integrated abatement system meets a destruction removal efficiency standard wherein the determination comprises the steps:
i) operating an electronic device manufacturing process tool using a best known method, whereby effluent containing a target species is produced;
ii) abating the target species to form abated effluent, using an abatement system which is coupled to the process tool; and
iii) calculating a destruction removal efficiency for the target species; and
b) modifying the abatement system by altering at least one of a design parameter and an operating parameter of the abatement system to improve the destruction removal efficiency.

2. The method of claim 1 further comprising:
c) repeating steps a) and b) at least once.

3. The method of claim 1 wherein the abatement system is modified by altering a design parameter.

4. The method of claim 3 wherein altering the design parameter comprises selecting an abatement tool for inclusion in the abatement system.

5. The method of claim 4 wherein the abatement tool is selected from the group consisting of wet scrubbers, burners, plasma units, filters, oxidizing units, thermal units; dry scrubbers, adsorbing units, absorbing units, catalyst units, and acid gas scrubbers.

6. The method of claim 3 wherein altering the design parameter comprises selecting a configuration for the abatement system.

7. The method of claim 6 wherein selecting the configuration for the abatement system the comprises selecting at least one of a size, a capacity, a physical configuration, and an order of one or more abatement tools.

8. The method of claim 1 wherein the step of calculating a destruction removal efficiency of the target species comprises measuring a mass flow rate of the target species produced by the process tool.

9. The method of claim 8 wherein the step of calculating a destruction removal efficiency of the target species further comprises measuring a mass flow rate of the target species in the abated effluent.

10. The method of claim 9 wherein the measurement of the mass flow rate of the target species comprises:
injecting an inert gas at a known mass flow rate into a conduit which contains the effluent, at a location upstream from a location where the mass flow rate of the target species will be measured;
measuring the concentration of the inert gas in the conduit which carries the inert gas and the target species;
measuring the concentration of the target species in the conduit which carries the inert gas and the target species;
calculating the total mass flow rate of the effluent in the conduit by dividing the mass flow rate of the inert gas by the concentration of the inert gas in the conduit; and
multiplying the total flow rate of the effluent by the concentration of the target species.

11. A method of developing an integrated abatement system comprising the steps:
operating an electronic device manufacturing process tool, whereby effluent is produced by the process tool;
abating the effluent, using an abatement system which is adapted to abate effluent from the process tool and to meet a destruction removal efficiency standard for the process tool when the process tool is operated using a best known method;
stressing the abatement system, wherein stressing the abatement system comprises introducing a precursor species into the process tool in an amount greater than an amount prescribed by the best known method;
calculating a destruction removal efficiency of the stressed abatement system for a target species; and
modifying the abatement system, by altering at least one of a design parameter and an operating parameter of the abatement system, to improve the destruction removal efficiency of the abatement system for the target species.

12. The method of claim 11 further comprising
continuing to stress the abatement system;
abating the effluent using the modified abatement system;
calculating a destruction removal efficiency of the modified abatement system; and
further modifying the abatement system, by altering at least one of a design parameter and an operating parameter.

13. The method of claim 11 wherein stressing the abatement system further comprises stabilizing a mass flow controller connected to the process tool.

14. The method of claim 11 wherein stressing the abatement system further comprises calibrating a mass flow controller connected to the process tool.

15. The method of claim 11 wherein stressing the abatement system further comprises simulating the failure a mass flow controller connected to the process tool, wherein the mass flow controller fails at a maximum flow.

16. A method of developing an integrated abatement system comprising the steps:
operating an electronic device manufacturing process tool using a best known method, whereby effluent is produced by the process tool;
abating the effluent to form abated effluent, using an abatement system which is adapted to abate effluent from the process tool and to meet a destruction removal efficiency standard;
measuring a mass flow rate of material entering the abatement system;
measuring a mass flow rate of material exiting the abatement system;
calculating a mass balance;
modifying the abatement system by altering at least one of a design parameter and an operating parameter of the abatement system to improve the mass balance.

17. The method of claim 16 further comprising:
calculating a mass balance for the modified abatement system, and
further modifying the abatement system by altering at least one of a design parameter and an operating parameter of the abatement system to improve the mass balance.

18. The method of claim 16 where the material is an atom.
